(19) United States
(12) Patent Application Publication
(10) Pub. No.: US 2013/0208756 A1
(43) Pub. Date: Aug. 15, 2013

(54) LOW TEMPERATURE MELTING FURNACE HAVING IMPROVED COOLING FLOW AND METAL SECTOR

(71) Applicants: Hyun Je CHO, Daejeon (KR); Deuk Man KIM, Daejeon (KR); Seok Mo CHOI, Daejeon (KR); Cheon Woo KIM, Daejeon (KR); Jung Kwon SON, Daejeon (KR); Tae Won HWANG, Daejeon (KR)

(72) Inventors: Hyun Je CHO, Daejeon (KR); Deuk Man KIM, Daejeon (KR); Seok Mo CHOI, Daejeon (KR); Cheon Woo KIM, Daejeon (KR); Jung Kwon SON, Daejeon (KR); Tae Won HWANG, Daejeon (KR)

(73) Assignee: KOREA HYDRO & NUCLEAR POWER CO., LTD., Gyeongsangbuk-do (KR)

(21) Appl. No.: 13/468,113

(22) Filed: May 10, 2012

(30) Foreign Application Priority Data
Feb. 14, 2012 (KR) 10-2012-0014737

(51) Int. Cl. H05B 6/06

(52) U.S. Cl. 373/158

(57) ABSTRACT

A low temperature melting furnace having improved cooling flow includes a wall including a plurality of metal sectors, wherein a metal sector includes a first metal sector and a second metal sector, which are formed in one unit, and a cooling passage through which a cooling water flows is formed in each of the first metal sector and the second metal sector, the first metal sector and the second metal sector being connected to each other through a connection unit.

### PRIORITY

This application claims the benefit under 35 U S. C. §119 a of a Korean patent application filed in the Korean Intellectual Property Office on Feb. 14, 2012 and assigned Serial No. 10-2012-0014737, and the entire disclosure of which is hereby incorporated by reference.

### BACKGROUND OF THE INVENTION

1. Field of the Invention

The present invention relates to a low temperature melting furnace having improved cooling flow and a metal sector in which a connection unit is provided to the metal sector to reduce heat caused by inductive current so that the metal sector may have a decreased thickness and thus a plurality of metal sectors may be provided in the low temperature melting furnace, thereby reducing an influence of the inductive current to improve energy efficiency.

2. Description of the Related Art

In a nuclear power plant, a protective clothing, PVC, vinyl sheet, waste, waste ion exchange resin, boric acid waste, slurry and a dried material that are produced during operation and maintenance of the nuclear power plant are placed altogether in a low temperature melting furnace that uses inductive current heating such that verified waste is generated to minimize an environmental impact as well as emission of a radioactive waste drum is reduced.

Generally, a melting furnace is an apparatus used for vitrificating waste contained within the melting furnace.

Prior art documents include, for example, Korean Patent No. 10-0348746, titled “Waste Treatment Apparatus,” Korean Patent Publication No. 10-2004-0010397, titled “Tapping Device of Melting Furnace and Molten Metal Heating Device,” and Korean Patent No. 10-1006751, titled “Core-Type Furnace.”

In the above prior art documents, a metal sector is provided to lower heat generated by inductive current transmitted from a high frequency generator to the melting furnace.

However, in a conventional metal sector of the melting furnace, an inlet and an outlet are required to allow a cooling water to flow in and out, and thus, the metal sector needs to have an increased area.

Also, since the metal sector has an increased area, space utilization as well as the influence of the inductive current is lowered, thereby reducing energy efficiency of the metal sector.

### SUMMARY OF THE INVENTION

Accordingly, the present invention has been made in view of the above problems, and the present invention is to provide a low temperature melting furnace capable of improving cooling flow and a metal sector, in which a limitation to a size of a cross section of the metal sector required to secure a cooling passage within the metal sector is minimized and cooling flow is improved, in a cooling structure for cooling a wall of the melting furnace comprising a plurality of metal sectors.

In one aspect of the present invention, a low temperature melting furnace having improved cooling flow includes a wall including a plurality of metal sectors, wherein a metal sector includes a first metal sector and a second metal sector, which are formed in one unit, and a cooling passage through which a cooling water flows is formed in each of the first metal sector and the second metal sector, the first metal sector and the second metal sector being connected to each other through a connection unit.

In one embodiment, an inlet/outlet groove may be formed in one end portion of each of the first metal sector and the second metal sector to allow inflow and outflow of the cooling water.

In one embodiment, the connection unit may be provided to be attachable or detachable to/from the metal sector.

In another aspect of the present invention, a metal sector that forms a wall of a low temperature melting furnace having improved cooling flow includes a first metal sector and a second metal sector, which are formed in one unit, wherein a cooling passage through which a cooling water flows is formed in each of the first metal sector and the second metal sector, the first metal sector and the second metal sector being connected to each other through a connection unit.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view illustrating a low temperature melting furnace having improved cooling flow, in which a metal sector is provided;

FIG. 2 is a front view illustrating a metal sector according to the present invention;

FIG. 3 is a front view illustrating a connection unit positioned between metal sectors according to the present invention; and

FIG. 4 is a cross sectional view illustrating circulation of a cooling water between metal sectors according to the present invention.

### DETAILED DESCRIPTION OF THE INVENTION

Exemplary embodiments of the present invention will be described herein below with reference to the accompanying drawings.

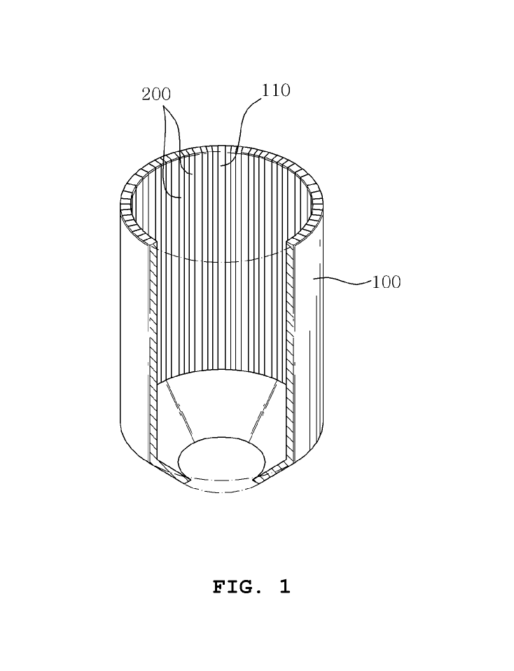

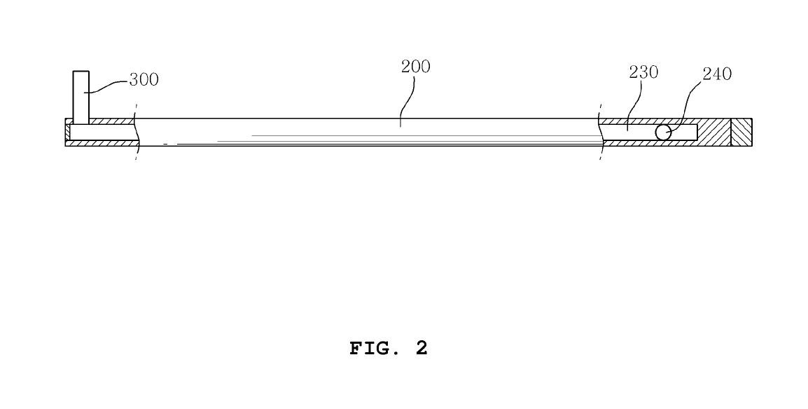

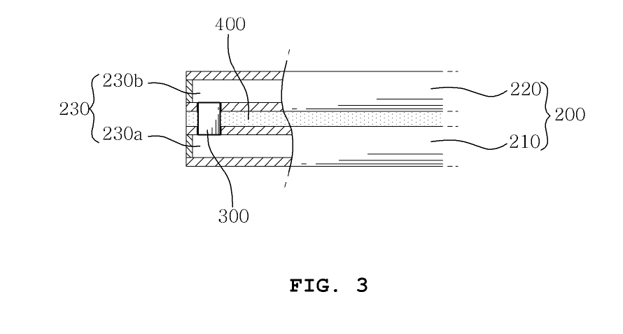

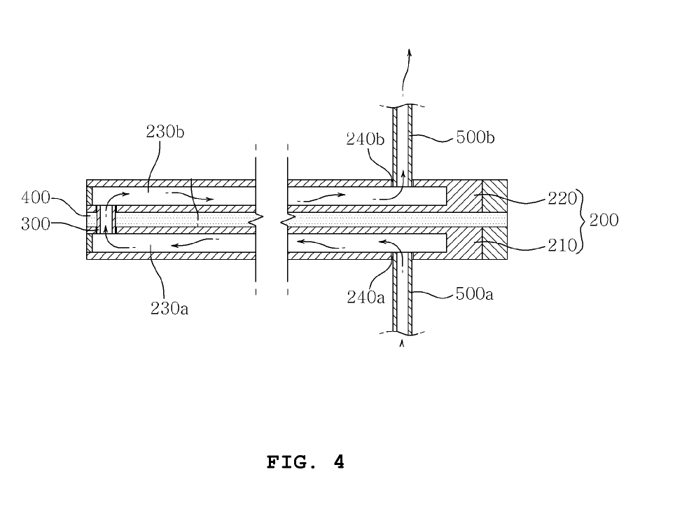

In a low temperature melting furnace having improved cooling flow according to the present invention, a plurality of metal sectors are used to form a wall of the low temperature melting furnace, as shown in FIG. 1, an inlet/outlet groove is formed in the metal sector, as shown in FIG. 2, a connection unit is connected between the metal sectors, as shown in FIG. 3, and a cooling water is circulated when the metal sectors are connected through the connection unit, as shown in FIG. 4.

As shown in FIG. 1, the low temperature melting furnace having improved cooling flow includes a low temperature melting furnace 100 and a metal sector 200.

The low temperature melting furnace 100 is formed in a cylindrical shape and contains radioactive and non-radioactive waste therein.

Specifically, the low temperature melting furnace 100 includes a container for containing the waste to be melted and a cover for sealing the contained waste.

The low temperature melting furnace 100 forms a wall 110 comprising a plurality of metal sectors 200.

As shown in FIG. 2, the metal sector 200 comprises stainless steel that is formed in a shape of a pipe that is closed at both ends and is elongated along a longitudinal direction of the low temperature melting furnace 100.

The metal sector 200 includes a first metal sector 210 and a second metal sector 220 that are formed in one unit.

The first metal sector 210 and the second metal sector 220 respectively have a cooling passage 230 formed therein to allow a cooling water to flow.

An inlet/outlet groove 240 is formed in one end portion of the metal sector 200, and another end portion is connected to a connection unit 300.

The inlet/outlet groove 240 is connected to the cooling passage 230 of the metal sector 200 so that the cooling water supplied through the inlet/outlet groove 240 flows through the cooling passage 230.

Accordingly, the cooling water may easily flows in and out by using the inlet/outlet groove 240.

The connection unit 300 is formed in a cylindrical shape and is connected to the metal sector 200 while protruding outwardly from the metal sector 200.

Specifically, one end portion of the connection unit 300 is connected to the cooling passage 230 of the metal sector 200 and the other end portion thereof protrudes in a direction outwardly from the metal sector 200.

The connection unit 300 may have a polygon shape and, in this exemplary embodiment, is formed in the cylindrical shape.

The connection unit 300 is connected between the first metal sector 210 and the second metal sector 220, which will be described below.

The connection unit 300 is provided to be attachable or detachable to/from the metal sector 200, and when the a component necessarily needs to be replaced due to wear and tear during use, the connection unit 300 is detached to replace a corresponding component.

Accordingly, time and cost for replacement may be reduced by using the connection unit 300.

As shown in FIG. 3, the metal sector 200 includes the first metal sector 210 and the second metal sector 220 that are formed in one unit, in which a cooling water externally provided is circulated.

The connection unit 300 connected to the first metal sector 210 is connected to the second metal sector 220 at the end portion that protrudes in an outward direction.

The connection unit 300 is inserted and connected to the second metal sector 220 and the connection unit 300 is connected with a second cooling passage 230b of the second metal sector 220.

The first metal sector 210 and the second metal sector 220 are separated from each other by an insulation material 400 filled therebetween.

The insulation material 400 comprises ceramic that has good physical, chemical and thermal stability, thereby avoiding electrical arc to minimize electrical damage.

As shown in FIG. 4, in the metal sector 200 that is formed in one unit, an inlet pipe 500a is inserted to an inlet/outlet groove 240a of the first metal sector 210 and an outlet pipe 500b is inserted to an inlet/outlet groove 240b of the second metal sector 220.

The inlet pipe 500a is formed in a pipe shape and is inserted to the inlet/outlet groove 240a of the first metal sector 210 and connected to a first cooling passage 230a of the first metal sector 210.

The inlet pipe 500a connected to the first cooling passage 230a is connected to a cooling water supplying apparatus, which is separately and externally provided, such that the cooling water is supplied to the first cooling passage 230a of the first metal sector 210 through the inlet pipe 500a.

The cooling flowing through the inlet pipe 500a flows to the connection unit 300 through the first cooling passage 230a.

The connection unit 300 transmits the cooling flowing through the first cooling passage 230a to the second cooling passage 230b of the second cooling sector 220.

The cooling flowing through the second cooling passage 230b is transmitted to the outlet pipe 500b connected to the second metal sector 220 so that the cooling water is discharged outside.

The outlet pipe 500b is formed in a pipe shape, similar to the inlet pipe 500a, and is inserted to the inlet/outlet groove 240b formed on the second metal sector 220, wherein the outlet pipe 500b is connected to the second cooling passage 230b of the second cooling sector 220.

Accordingly, the cooling water may easily be circulated in the metal sector 200 by the inlet pipe 500a and the outlet pipe 500b.

A condition of use and an operation of the low temperature melting furnace having improved cooling flow and the metal sector that is configured as described above according to the present invention are described below.

First, as shown in FIGS. 1 and 3, the low temperature melting furnace 100 having the improved cooling flow and the metal sector 200 are standardized and modularized in a factory beforehand, thereby improving work efficiency at a work site.

The first metal sector 210 of the metal sector 200 has one end portion connected to the connection unit 300 and the connection unit 300 is inserted to the first cooling passage 230a of the first metal sector 210.

The connection unit 300 has one end portion connected to the first metal sector 210 and the other end portion connected to the second metal sector 220.

Similar to a connection relationship between the first metal sector 210 and the connection unit 300, the second metal sector 220 is inserted to the second cooling passage 230b of the second metal sector 220.

The first metal sector 210 and the second metal sector 220 are connected by the connection unit 300 to be formed in one unit.

The metal sector 200 formed in one unit is attached to the wall 110 of the low temperature melting furnace 100 and the insulation material 400 fills therebetween.

As shown in FIG. 4, in the metal sector 200 formed in one unit, the inlet pipe 500a is inserted to the inlet/outlet groove 240a of the first metal sector 210 and the outlet pipe 500b is inserted to the inlet/outlet groove 240b of the second metal sector 220 in which another inlet/outlet groove 240b is formed.

The inlet pipe 500a is connected to a separate cooling water supplying apparatus to supply a cooling water through the inlet pipe 500a.

The cooling water supplied through the inlet pipe 500a flows to the first cooling passage 230a of the first metal sector 210 and flows to the second cooling passage 230b of the second metal sector 220 through the connection unit 300 connected to the first cooling passage 230a.

The cooling flowing through the second cooling passage 230b is discharged outside through the outlet pipe 500b connected to the second cooling passage 230b.

According to the present invention, in the low temperature melting furnace having improved cooling flow and the metal sector, one cooling passage is formed in each of a pair of metal sectors, which is connected to each other to form to form one cooling structure, so that each of the metal sectors may have a decreased size and the number of the metal sectors may be increased without increasing a predefined size of the low temperature melting furnace, thereby lowering influence of inductive current to improve energy efficiency and increasing a cooling flow rate to improve cooling effect.

In the above, although the embodiments of the present invention have been described with reference to the accompanying drawings, a person skilled in the art should apprehend that the present invention can be embodied in other specific forms without departing from the technical spirit or essential characteristics thereof. Thus, the embodiments described above should be construed as exemplary in every aspect and not limiting.

1. A low temperature melting furnace having improved cooling flow comprising a wall comprising a plurality of metal sector units, each metal sector unit including:
a first metal sector and a second metal sector, the first metal sector having a first cooling passage and an inlet hole for receiving an inflow of cooling water into the first cooling passage, the second metal sector having a second cooling passage and an outlet hole for an outflow of the cooling water from the second cooling passage, the first and second cooling passages each being closed at opposite first and second ends of the metal sector unit, the inlet hole and the outlet hole being adjacent said first end;
a connection unit providing fluid communication between the first cooling passage and the second cooling passage, the connection unit being adjacent said second end; and
an insulation material filling a space between the first metal sector and a second metal sector.

2. (canceled)

3. The low temperature melting furnace according to claim 1, wherein the connection unit is removably attached to the metal sector.

4. A metal sector unit forming a wall of a low temperature melting furnace having improved cooling flow, the metal sector unit comprising:
a first metal sector and a second metal sector, the first metal sector unit having a first cooling passage and an inlet hole for receiving an inflow of cooling water into the first cooling passage, the second metal sector unit having a second cooling passage and an outlet hole for an outflow of the cooling water from the second cooling passage, the first and second cooling passages being closed at opposite first and second ends of the metal sector unit, the inlet hole and the outlet hole being adjacent said first end;
a connection unit providing fluid communication between the first cooling passage and the second cooling passage, the connection unit being adjacent said second end; and
an insulation material filling a space between the first metal sector and a second metal sector.
